(19) United States
(12) Patent Application Publication
(10) Pub. No.: US 2020/0232320 A1
(43) Pub. Date: Jul. 23, 2020

(54) FOUR-DOUBLE WORKING METHOD FOR RISK ASSESSMENT AND PREDICTION OF WATER INRUSH AT ROOF AQUIFER OF COAL SEAM

(71) Applicant: Inner Mongolia Shanghaimiao Mining Co. Ltd., Ordos City (CN)

(72) Inventors: Yuguang LV, Ordos City (CN); Qinghua XIAO, Ordos City (CN); Yujun XIA, Ordos City (CN); Guangyin CHEN, Ordos City (CN); Zhijie WEN, Ordos City (CN); Gang HAN, Ordos City (CN); Wenqing LV, Ordos City (CN)

(21) Appl. No.: 16/743,653

(22) Filed: Jan. 15, 2020

(30) Foreign Application Priority Data
Jan. 17, 2019 (CN) 201910045501.4

(51) Int. Cl. E21C 41/16; G01N 15/08

(52) U.S. Cl. CPC E21C 41/04; G01N 15/08

(57) ABSTRACT

The present invention discloses a four-double working method for danger assessment and prediction of water inrush in a roof aquifer of a coal seam, and belongs to the coal mining field. The method includes: calculating a water abundance index and/or a danger index of water inrush of a roof of a to-be-mined coal seam according to position classification of the roof of the to-be-mined coal seam; and obtaining a water inrush assessment result of the roof of the to-be-mined coal seam according to the water abundance index and/or the danger index of water inrush of the roof of the to-be-mined coal seam and excavation area position information of the roof of the to-be-mined coal seam. The present invention resolves the problem that current water abundance assessment and danger assessment and prediction of water inrush are complex and inaccurate.

### TECHNICAL FIELD

The present invention relates to the field of coal mining technologies, and specifically, to a four-double working method for danger assessment and prediction of water inrush in a roof aquifer of a coal seam.

### BACKGROUND

Water inrush in a roof aquifer has been one of main factors affecting the safety production of coal mines and the sustainable development of the coal mining industry in China. Water inrush in a mine roof not only deteriorates the production environment of a working face, but also brings a certain safety risk to mine production. If the water abundance of sandstone in a roof is not well assessed, and a water inflow quantity of the roof is inappropriately predicted, the following two cases usually occur: (1) A safety factor is excessively increased, which greatly increases costs of prevention and control engineering. (2) A safety factor is excessively small but there are inadequate waterproofing and drainage in a mining area, resulting in flooding of a mine and the mining area, even a serious casualty accident. It can be learned that during mining, it is necessary to assess the water abundance and water inrush danger of a roof; and it is also necessary to predict a drainage water yield of a to-be-mined working surface.

However, in the prior art, a method for water abundance assessment of roof sandstone is excessively complex and imposes a relatively high data requirement. Moreover, there is a relatively large difference between assessment results of conventional methods for danger assessment of water inrush, and the application of these methods is limited to some extent. Currently, there is no desirable way to predict a yield of water to be drained in advance.

### SUMMARY

An objective of the present invention is to provide a four-double working method for danger assessment and prediction of water inrush in a roof aquifer of a coal seam, to overcome the above deficiencies in the prior art. The method resolves the problems that current water abundance assessment and danger assessment and prediction of water inrush are complex and inaccurate and it is almost impossible to predict a drainage water yield, thereby providing guidance for underground drainage engineering.

To achieve the above objective, a technical solution adopted in embodiments of the present invention is as follows:

The embodiments of the present invention provide a method for assessing water abundance and water inrush and predicting a drainage water yield. The method includes: calculating a water abundance index and/or a danger index of water inrush of a roof of a to-be-mined coal seam according to position classification of the roof of the to-be-mined coal seam; and obtaining a water inrush assessment result of the roof of the to-be-mined coal seam according to the water abundance index and/or the danger index of water inrush of the roof of the to-be-mined coal seam and excavation area position information of the roof of the to-be-mined coal seam.

Optionally, the calculating a water abundance index of a roof of a to-be-mined coal seam includes:

obtaining borehole histogram information of all boreholes of the to-be-mined coal seam; obtaining a coal seam thickness of an adjacent fractured aquifer of the to-be-mined coal seam according to the borehole histogram information; obtaining a coal seam mining height according to the coal seam thickness; obtaining a thickness of a theoretical research stratum according to the coal seam thickness and the coal seam mining height; obtaining a thickness of an additional layer and a total thickness of a sandstone layer in a research section according to the lithology of the coal seam, a single layer thickness, and a burial depth of a floor; obtaining a thickness of an adopted research stratum according to the thickness of the theoretical research stratum and the thickness of the additional layer; and determining the water abundance index of the roof of the to-be-mined coal seam according to the total thickness of the sandstone layer in the research section and the thickness of the adopted research stratum.

Optionally, the calculating a height of a water flowing fractured zone according to the coal seam mining height includes: calculating the height H_{D} of the water flowing fractured zone according to a formula H_{D}=100M÷(3.1M+5)+4, and calculating a thickness H_{b} of a protective layer according to H_{b}=4M, where M represents the coal seam mining height.

Optionally, the determining the water abundance index of the roof of the to-be-mined coal seam according to the total thickness of the sandstone layer in the research section and the thickness of the adopted research stratum includes:

calculating the water abundance index F_{zhi} according to a formula

$${F}_{z h i} = \frac{{M}_{C}}{{H}_{Y}} \times 100 \% ,$$

where M_{C} represents the total thickness of the sandstone layer; and H_{Y} represents the thickness of the adopted research stratum.

Optionally, the calculating a danger index of water inrush of a roof of a to-be-mined coal seam includes:

obtaining borehole histogram information of all boreholes of the to-be-mined coal seam; obtaining a coal seam thickness of an adjacent fractured aquifer of the to-be-mined coal seam, an impervious layer thickness, and a thickness of a waterproof coal pillar according to the borehole histogram information; obtaining a coal seam mining height according to the coal seam thickness; determining a height of a water flowing fractured zone and a thickness of a protective layer according to the coal seam mining height; and calculating the danger index of water inrush of the roof of the to-be-mined coal seam according to the height of the water flowing fractured zone, the impervious layer thickness, the thickness of the waterproof coal pillar, and the thickness of the protective layer.

Optionally, the calculating the danger index of water inrush of the roof of the to-be-mined coal seam according to the height of the water flowing fractured zone, the impervious layer thickness, the thickness of the waterproof coal pillar, and the thickness of the protective layer includes:

calculating the danger index of water inrush Tₛ according to a formula

$${T}_{s} = \frac{{H}_{g} - {H}_{d} - {H}_{b} + {d}_{x}}{{H}_{f}} ,$$

where H_{g} represents the impervious layer thickness; H_{f} represents the thickness of the waterproof coal pillar; H_{d} represents the height of the water flowing fractured zone; and H_{b} represents the thickness of the protective layer.

Optionally, the obtaining a water inrush assessment result of the roof of the to-be-mined coal seam according to the water abundance index and/or the danger index of water inrush of the roof of the to-be-mined coal seam and excavation area position information of the roof of the to-be-mined coal seam includes:

drawing a contour map of water abundance according to the water abundance index; drawing a contour map of water inrush danger according to the danger index of water inrush; and obtaining the water inrush assessment result of the roof of the to-be-mined coal seam according to the contour map of water abundance, the contour map of the water inrush danger, and the excavation area position information of the roof of the to-be-mined coal seam.

Optionally, after the obtaining the water inrush assessment result of the roof of the to-be-mined coal seam, the method further includes:

if the water inrush assessment result indicates that water inrush danger satisfies a preset condition, calculating a drainage water yield of a to-be-mined working face of the to-be-mined coal seam according to the water abundance index of the to-be-mined coal seam and a preset algorithm.

Optionally, the calculating a drainage water yield of a to-be-mined working face of the to-be-mined coal seam according to the water abundance index of the to-be-mined coal seam and a preset algorithm includes:

obtaining a drainage water yield, a mining area, and a mining height of a mined working face; calculating an average water abundance index of the mined working face according to water abundance indexes corresponding to all boreholes of the mined working face; determining a mining area of the to-be-mined working face; determining a designed mining height of the to-be-mined working face; calculating an average water abundance index of the to-be-mined working face according to water abundance indexes corresponding to all boreholes of the to-be-mined working face; and

predicting a drainage water yield of the to-be-mined working face according to a formula

$${Q}_{to \text{-} be \text{-} mined} = \frac{{F}_{zhi to \text{-} be \text{-} mined} \times {S}_{to \text{-} be \text{-} mined} \times {D}_{to \text{-} be \text{-} mined}}{{F}_{zhi mined} \times {S}_{mined} \times {D}_{mined}} \times {Q}_{mined} ,$$

where Q_{to-be-mined} represents the drainage water yield of the to-be-mined working face; Q_{mined} represents the drainage water yield of the mined working face; F_{zhi to-be-mined} represents the average water abundance index of the to-be-mined working face; F_{zhi mined} represents the average water abundance index of the mined working face; S_{mined} represents the mining area of the mined working face; S_{to-be-mined} represents the mining area of the to-be-mined working face; D_{mined} represents an average mining height of the mined working face; and D_{to-be-mined} represents the designed mining height of the to-be-mined working face.

The present invention has the following beneficial effects:

The four-double working method for danger assessment and prediction of water inrush in a roof aquifer of a coal seam provided in the present invention includes: calculating a water abundance index and/or a danger index of water inrush of a roof of a to-be-mined coal seam according to position classification of the roof of the to-be-mined coal seam; and obtaining a water inrush assessment result of the roof of the to-be-mined coal seam according to the water abundance index and/or the danger index of water inrush of the roof of the to-be-mined coal seam and excavation area position information of the roof of the to-be-mined coal seam. The method resolves the problem that current water abundance assessment and danger assessment and prediction of water inrush are complex and inaccurate. In addition, the method can resolve the problem that it is almost impossible to predict a drainage water yield currently, thereby providing guidance for underground drainage engineering.

### BRIEF DESCRIPTION OF DRAWINGS

To describe the technical solutions in the embodiments of the present invention more clearly, the following briefly describes the accompanying drawings required for describing the embodiments. It should be understood that, the following accompanying drawings show merely some embodiments of the present invention, and therefore should not be regarded as a limitation on the scope. A person of ordinary skill in the art may still derive other related drawings from these accompanying drawings without creative efforts.

FIG. 1 is a schematic flowchart of a method for assessment of water inrush in a roof aquifer of a coal seam according to an embodiment of the present invention;

FIG. 2 is a schematic diagram 1 of position classification of a roof according to the present invention;

FIG. 3 is a schematic diagram 2 of position classification of a roof according to the present invention;

FIG. 4 is a schematic diagram 3 of position classification of a roof according to the present invention;

FIG. 5 is a schematic diagram 4 of position classification of a roof according to the present invention;

FIG. 6 is a schematic flowchart of a method for water abundance assessment of a roof aquifer of a coal seam according to another embodiment of the present invention;

FIG. 7 is a schematic flowchart of a method for danger assessment of water inrush in a roof aquifer of a coal seam according to another embodiment of the present invention; and

FIG. 8 is a schematic flowchart of a method for predicting a drainage water yield according to another embodiment of the present invention.

In reference signs, 01—indirect roof; 02—immediate roof; and 03—to-be-mined coal seam.

### DETAILED DESCRIPTION

To make the objectives, technical solutions, and advantages of the embodiments of the present invention clearer, the following clearly and completely describes the technical solutions in the embodiments of the present invention with reference to accompanying drawings in the embodiments of the present invention. Apparently, the described embodiments are some rather than all of the embodiments. Generally, components of embodiments of the present invention described and shown in the accompanying drawings may be arranged and designed in various manners.

Therefore, the following detailed description of the embodiments of the present invention in the accompanying drawings is not intended to limit the protection scope of the present invention, but merely represent selected embodiments of the present invention. All other embodiments obtained by a person of ordinary skill in the art based on the embodiments of the present invention without creative efforts shall fall within the protection scope of the present invention. All other embodiments obtained by a person of ordinary skill in the art based on the embodiments of the present invention without creative efforts shall fall within the protection scope of the present invention.

It should be noted that similar reference signs and letters represent similar items in the accompanying drawings below. Therefore, once an item is defined in one drawing, it does not need to be further defined and described in subsequent drawings.

In the description of the present invention, it should be noted that orientations or position relationships indicated by terms “center”, “upper”, “lower”, “left”, “right”, “vertical”, “horizontal”, “inner”, “outer”, etc. are orientation or position relationships shown in the accompanying drawings, and these terms are only used to facilitate description of the present invention and simplify the description, but not to indicate or imply that the mentioned apparatus or components must have a specific orientation or must be established and operated in a specific orientation, and thus these terms cannot be understood as a limitation to the present invention. In addition, the terms such as “first”, “second”, and “third” are used only for the purpose of description and cannot be understood to indicate or imply relative importance.

Moreover, terms such as “horizontal” and “vertical” do not mean that a component is absolutely horizontal or overhanging, but that it can be tilted slightly. If “horizontal” only means that a direction of the component is more horizontal than “vertical”, it does not mean that the structure must be completely horizontal, but can be tilted slightly.

### Embodiment 1

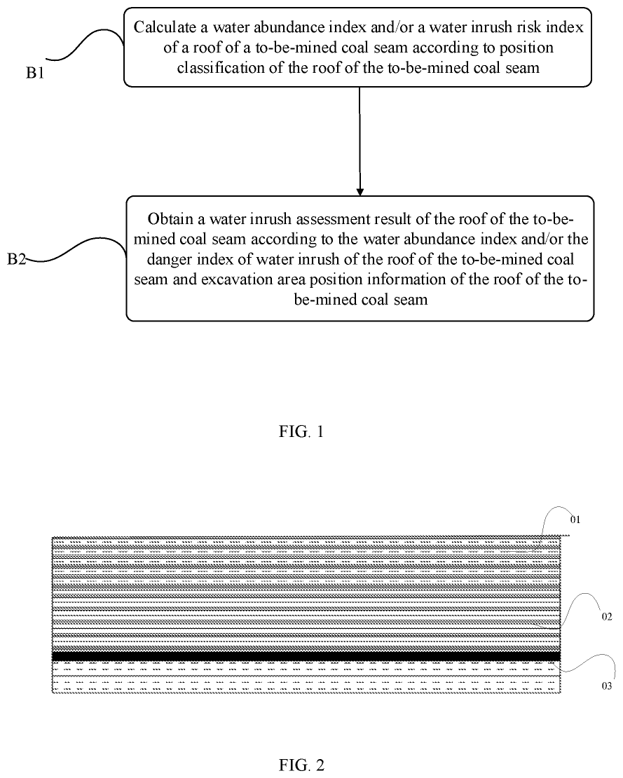

FIG. 1 shows a four-double working method for danger assessment and prediction of water inrush in a roof aquifer of a coal seam according to an embodiment of the present invention. The method includes the following steps:

Step B 1. Calculate a water abundance index and/or a danger index of water inrush of a roof of a to-be-mined coal seam according to position classification of the roof of the to-be-mined coal seam.

For position classification of the roof of the coal seam, refer to FIG. 2 to FIG. 5. The to-be-mined coal seam is a to-be-mined coal seam 03 in the figures. Roofs may include an immediate roof 02 and an indirect roof 01, where the immediate roof 02 is in contact with the to-be-mined coal seam 03, and the indirect roof 01 is in contact with the immediate roof 02.

Further, a water inrush assessment result of the to-be-mined coal seam 03 is obtained by comprehensive determining according to whether the to-be-mined coal seam 03 is in conformable contact with the immediate roof 02, the water abundance of the immediate roof 02 and the indirect roof 01, and the lithology of the immediate roof 02 and the indirect roof 01.

Step B2. Obtain a water inrush assessment result of the roof of the to-be-mined coal seam according to the water abundance index and/or the danger index of water inrush of the roof of the to-be-mined coal seam and excavation area position information of the roof of the to-be-mined coal seam.

It should be noted that, “four double” indicates double tables, double indexes, double plots, and double prediction. The double tables represent a basic data table composed of information extracted according to borehole histograms and a work table organized according to the basic data table in combination with calculation processes of a water abundance index and a danger index of water inrush. The double indexes represent the water abundance index and the danger index of water inrush. The double plots represent a contour map of water abundance and a contour map of water inrush danger. The double prediction represents prediction of a drainage water yield and prediction of a water inflow quantity.

FIG. 2 is a schematic diagram 1 of position classification of the roof according to the present invention. Referring to FIG. 2, the immediate roof 02 is a sand-mud interbedded aquifer with uneven water abundance; the to-be-mined coal seam 03 is in conformable contact with overlying strata; and a water flowing fractured zone of the to-be-mined coal seam 03 does not extend to an aquifer of the indirect roof 01. When position classification of the roof of the to-be-mined coal seam 03 is the type shown in FIG. 2, because the water flowing fractured zone of the to-be-mined coal seam 03 does not extend to the indirect roof 01, water inrush of the roof of the coal seam is assessed through calculation of a water abundance index of the immediate roof 02.

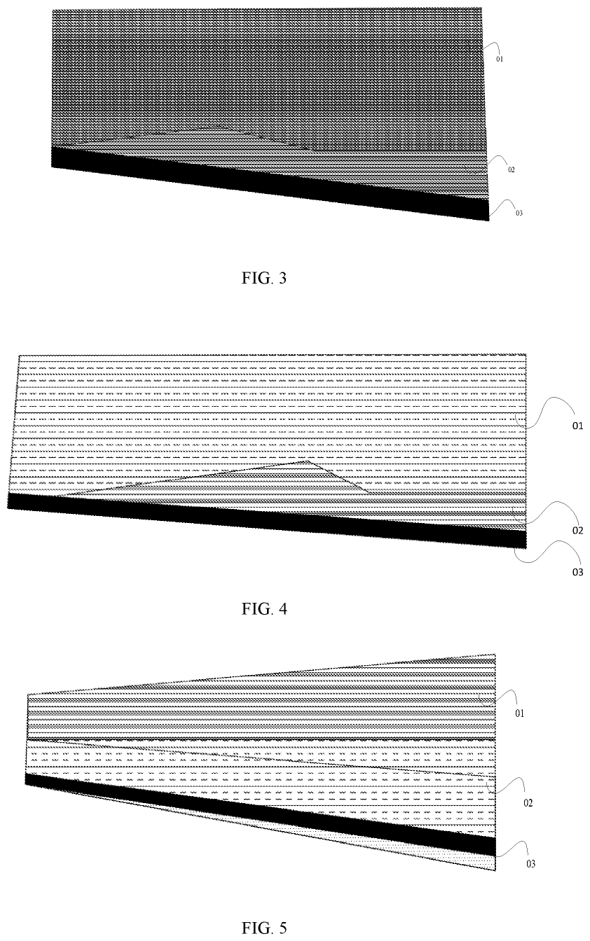

FIG. 3 is a schematic diagram 2 of position classification of the roof according to the present invention. The immediate roof 02 and the indirect roof 01 have same or similar geological conditions. Therefore, the immediate roof 02 and the indirect roof 01 can be regarded as located in a same stratum. When position classification of the roof of the coal seam is the type shown in FIG. 3, because the immediate roof 02 and the indirect roof 01 have same or similar geological conditions, whether a water flowing fractured zone can extend to the indirect roof 01 is not considered, and the immediate roof 02 and the indirect roof 01 are regarded as located in a same stratum for assessment. In this case, water inrush of the roof of the coal seam is assessed by only calculating a water abundance index of the roof of the to-be-mined coal seam 03.

FIG. 4 is a schematic diagram 3 of position classification of the roof according to the present invention. The indirect roof 01 has strong water abundance and the immediate roof 02 has weak water abundance. Water inrush occurs provided that a water flowing fractured zone extends to the indirect roof 01. In addition, because the immediate roof 02 has uneven thicknesses, a water flowing fractured zone in some areas can extend to the indirect roof 01 during mining of the to-be-mined coal seam 03. When position classification of the roof of the to-be-mined coal seam 03 is the type shown in FIG. 4, because the indirect roof 01 has strong water abundance and the immediate roof 02 has uneven thicknesses, water inrush occurs provided that the water flowing fractured zone extends to the indirect roof 01. In this case, water inrush of the roof of the coal seam is assessed through calculation of a danger index of water inrush of the immediate roof 02.

FIG. 5 is a schematic diagram 4 of position classification of the roof according to the present invention. The immediate roof 02 is an impervious layer, the indirect roof 01 is a sand-mud interbedded stratum with uneven water abundance, and a distance between the to-be-mined coal seam 03 and the indirect roof 01 is not fixed. A water flowing fractured zone sometimes extends to an aquifer of the indirect roof 01. When position classification of the roof of the to-be-mined coal seam 03 is the type shown in FIG. 5, the immediate roof 02 is an impervious layer, and the indirect roof 01 is a sand-mud interbedded stratum with uneven water abundance. In this case, whether a water flowing fractured zone can extend to the indirect roof 01 shall be considered, and whether a range to which the water flowing fractured zone extends has strong water abundance also needs to be considered. Therefore, for this type of stratum, a danger index of water inrush of the indirect roof 01 needs to be calculated, and a water abundance index and a danger index of water inrush of the immediate roof 02 also need to be calculated, to jointly assess water inrush of the roof of the coal seam.

It should be noted that, different strata have different water abundance, but this does not mean that all strata are aquifers. The concepts of the immediate roof 02 and the indirect roof 01 are provided only for clearer description of the present invention.

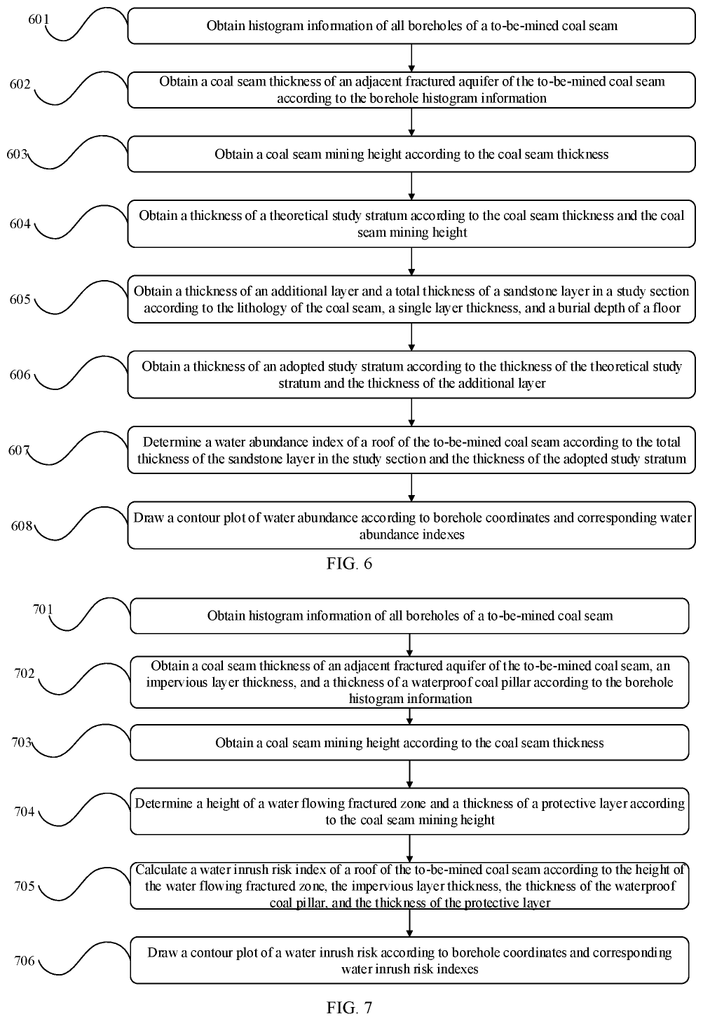

FIG. 6 is a schematic flowchart of a method for water abundance assessment of a roof aquifer of a coal seam according to another embodiment of the present invention.

Optionally, the calculating a water abundance index of a floor of a to-be-mined coal seam specifically includes:

Step 601. Obtain borehole histogram information of all boreholes of the to-be-mined coal seam.

The borehole histogram information of all the boreholes of the to-be-mined coal seam is obtained according to physical logging information obtained during geological exploration of a coal mine. The borehole histogram information includes a name, lithology, a thickness, a marker bed, an interlayer spacing, a borehole elevation, pore coordinates, a burial depth of an aquifer floor, a burial depth of a coal seam floor, etc. of each stratum.

Step 602. Obtain a coal seam thickness of an adjacent fractured aquifer of the to-be-mined coal seam according to the borehole histogram information.

After the borehole histogram information is obtained, information about the coal seam thickness of the adjacent fractured aquifer of the to-be-mined coal seam is extracted from the borehole histogram information.

Step 603. Obtain a coal seam mining height according to the coal seam thickness.

The coal seam mining height is obtained according to the coal seam thickness. The coal seam mining height can be determined according to the coal seam thickness and a maximum and minimum mining height of a fully-mechanized mining support. The maximum and minimum mining heights are determined according to the fully-mechanized mining support, and the coal seam thickness is compared with the minimum and maximum mining height. When the coal seam thickness is less than or equal to the minimum mining height, the minimum mining height is set as the coal seam mining height; when the coal seam thickness is greater than or equal to the maximum mining height, the maximum mining height is set as the coal seam mining height; when the coal seam thickness is between the minimum mining height and the maximum mining height, the coal seam mining height is determined according to a mining height of the fully-mechanized mining support.

Step 604. Obtain a thickness of a theoretical research stratum according to the coal seam thickness and the coal seam mining height.

First, a height of a water flowing fractured zone and a thickness of a protective layer are calculated according to the coal seam mining height. The calculating a height of a water flowing fractured zone according to the coal seam mining height may be calculating the height H_{D} of the water flowing fractured zone by using a formula H_{D}=100M÷(3.1M+5)+4, where M represents the coal seam mining height.

It should be noted that, when the water flowing fractured zone is directly used as a research section, a research range may be relatively small sometimes. In this case, the research range needs to be further determined through the protective layer to obtain accurate data. Optionally, the determining a thickness of a protective layer according to the coal seam mining height may be calculating the thickness H_{b} of the protective layer by using a formula H_{b}=4M, where H_{b} represents the thickness of the protective layer.

It should be noted that, a proportional relationship between the thickness of the protective layer and the coal seam mining height is provided only according to an empirical formula. The proportional relationship between the mining height and the thickness of the protective layer is not limited, and a specific proportional relationship should be provided based on an empirical formula and an actual mining situation. Herein, the foregoing case is only used as an example.

Step 604 may further include determining a revision value according to the coal seam thickness and the coal seam mining height.

Specifically, if a roof of a preset thickness is reserved at a coal mining face during mining, the preset thickness is a revision value; if a coal mining face is along a roof of a coal seam during mining, a revision value is 0; and if a coal mining face passes through roof rock during mining, a revision value is a thickness of the roof rock.

Finally, the thickness H_{Y} theoretical research stratum is determined according to a formula H_{Y}=H_{D}−dₓ, where H_{D} represents the height of the water flowing fractured zone; and dₓ represents the revision value.

It should be noted that, when the water flowing fractured zone is directly used as a research section, a research range may be relatively small sometimes. In this case, the research range needs to be further determined through the protective layer to obtain accurate data.

Step 605. Obtain a thickness of an additional layer and a total thickness of a sandstone layer in a research section according to the lithology of the coal seam, a single layer thickness, and a burial depth of a floor.

Specifically, the lithology of overlying strata of a theoretical research section is analyzed according to the borehole histogram information. If the overlying strata of the theoretical research section have strong water abundance, to obtain accurate data, when an actual research section is studied, the overlying strata of the theoretical research section should also be considered as an additional layer. In addition, a total thickness of a sandstone layer in the theoretical research section is determined according to a thickness of the theoretical research section and the borehole histogram information.

It should be noted that, when overlying roof strata of the theoretical research section have weak water abundance, an additional layer may not be considered.

Step 606. Obtain a thickness of an adopted research stratum according to the thickness of the theoretical research stratum and the thickness of the additional layer.

Optionally, the thickness H_{Y} of the adopted research stratum is calculated according to a formula H_{Y}=H_{D}−dₓ+d_{f}, where H_{D} represents the height of the water flowing fractured zone; dₓ represents the revision value; and d_{f} represents the thickness of the additional layer.

Step 607. Determine the water abundance index of the roof of the to-be-mined coal seam according to the total thickness of the sandstone layer in the research section and the thickness of the adopted research stratum.

Optionally, the water abundance index F_{zhi} is calculated according to a formula

$${F}_{z h i} = \frac{{M}_{C}}{{H}_{Y}} \times 100 \% ,$$

where M_{C} represents the total thickness of the sandstone layer; and H_{Y} represents the height of the research section.

It should be noted that, when the water abundance index is considered, the thickness of the additional layer also needs to be considered. When overlying strata of the research section have strong water abundance, the water abundance index can be calculated by

$${F}_{z h i} = \frac{{M}_{C} + {d}_{f}}{{H}_{Y} + {d}_{f}} \times 100 \% ,$$

to obtain data as accurate as possible with an error as small as possible, where d_{f} represents the thickness of the additional layer.

Step 608. Draw a contour map of water abundance according to borehole coordinates and corresponding water abundance indexes.

Optionally, the contour map of water abundance is drawn according to coordinate information of the boreholes in the borehole histogram information and water abundance indexes corresponding to all the boreholes.

FIG. 7 is a schematic flowchart of a method for danger assessment of water inrush in a roof aquifer of a coal seam according to another embodiment of the present invention.

As shown in FIG. 7, the calculating a danger index of water inrush of a floor of a to-be-mined coal seam includes:

Step 701. Obtain histogram information of all boreholes of the to-be-mined coal seam.

The borehole histogram information of all the boreholes of the to-be-mined coal seam is obtained according to physical logging information obtained during geological exploration of a coal mine. The borehole histogram information may include one or more of a name, lithology, a thickness, a marker bed, an interlayer spacing, a borehole elevation, pore coordinates, a burial depth of an aquifer floor, a burial depth of a coal seam floor, etc. of each stratum.

Step 702. Obtain a coal seam thickness of an adjacent fractured aquifer of the to-be-mined coal seam, an impervious layer thickness, and a thickness of a waterproof coal pillar according to the borehole histogram information.

After the borehole histogram information is obtained, information about the coal seam thickness of the adjacent fractured aquifer of the to-be-mined coal seam, the impervious layer thickness, the thickness of the waterproof coal pillar is extracted from the borehole histogram information.

Step 703. Obtain a coal seam mining height according to the coal seam thickness.

The coal seam mining height is obtained according to the coal seam thickness. The coal seam mining height can be determined according to the coal seam thickness and a maximum and minimum mining height of a fully-mechanized mining support. The maximum and minimum mining heights are determined based on the fully-mechanized mining support, and the coal seam thickness is compared with the minimum and maximum mining height. When the coal seam thickness is less than or equal to the minimum mining height, the minimum mining height is set as the coal seam mining height; when the coal seam thickness is greater than or equal to the maximum mining height, the maximum mining height is set as the coal seam mining height; when the coal seam thickness is between the minimum mining height and the maximum mining height, the coal seam mining height is determined according to a mining height of the fully-mechanized mining support.

Step 704. Determine a height of a water flowing fractured zone and a thickness of a protective layer according to the coal seam mining height.

The determining a height of a water flowing fractured zone according to the coal seam mining height may be calculating the height H_{D} of the water flowing fractured zone by using a formula H_{D}=100M÷(3.1M+5)+4, where M represents the coal seam mining height.

It should be noted that, when the water flowing fractured zone is directly used as a research section, a research range may be relatively small sometimes. In this case, the research range needs to be further determined through the protective layer to obtain accurate data. Optionally, the determining a thickness of a protective layer according to the coal seam mining height may be calculating the thickness H_{b} of the protective layer by using a formula H_{b}=4M, where H_{b} represents the thickness of the protective layer.

It should be noted that, a proportional relationship between the thickness of the protective layer and the coal seam mining height is provided only according to an empirical formula. The proportional relationship between the mining height and the thickness of the protective layer is not limited, and a specific proportional relationship should be provided based on an empirical formula and an actual mining situation. Herein, the foregoing case is only used as an example.

Step 705. Calculate the danger index of water inrush of the roof of the to-be-mined coal seam according to the height of the water flowing fractured zone, the impervious layer thickness, the thickness of the waterproof coal pillar, and the thickness of the protective layer.

Optionally, the danger index of water inrush Tₛ is calculated according to a formula

$${T}_{s} = \frac{{H}_{g} - {H}_{D} - {H}_{b} + {d}_{x}}{{H}_{f}} ,$$

where H_{g} represents the impervious layer thickness; H_{f} represents the thickness of the waterproof coal pillar; H_{D} represents the height of the water flowing fractured zone; and H_{b} represents the thickness of the protective layer.

Step 706. Draw a contour map of water inrush danger according to borehole coordinates and corresponding danger indexes of water inrush.

Optionally, the contour map of the water inrush danger is drawn according to coordinate information of the boreholes in the borehole histogram information and danger indexes of water inrush corresponding to all the boreholes.

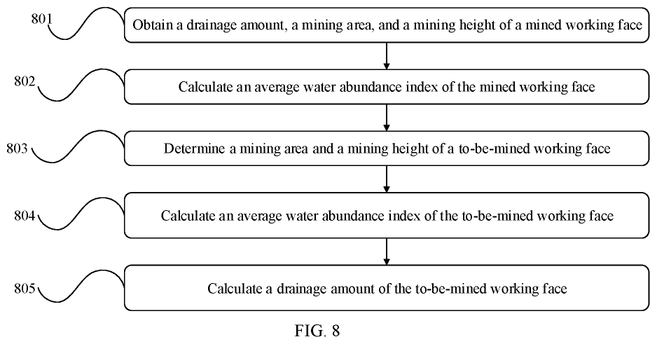

FIG. 8 is a schematic flowchart of a method for predicting a drainage water yield according to another embodiment of the present invention. The method includes the following steps:

Step 801. Obtain a drainage water yield, a mining area, and a mining height of a mined working face.

Information about a drainage water yield, a mining area, and a mining height of a mined working face that is located at a same coal seam as a to-be-mined working face is extracted from previously acquired data about a coal mine.

Step 802. Calculate an average water abundance index of the mined working face.

The average water abundance index of the mined working face is calculated by averaging water abundance indexes corresponding to all boreholes of the mined working face.

Step 803. Determine a mining area and a mining height of a to-be-mined working face.

A specified mining height of the to-be-mined working face is determined based on an actual situation according to a coal seam thickness and a maximum and minimum mining height of a fully-mechanized mining support; and the mining area of the to-be-mined working face is determined according to the specified mining height and a working width of coal mining equipment.

Step 804. Calculate an average water abundance index of the to-be-mined working face.

The average water abundance index of the to-be-mined working face is calculated by averaging water abundance indexes corresponding to all boreholes of the to-be-mined working face.

Step 805. Calculate a drainage water yield of the to-be-mined working face.

Optionally, the drainage water yield of the to-be-mined working face is calculated according to a formula

$${Q}_{to \text{-} be \text{-} mined} = \frac{{F}_{zhi to \text{-} be \text{-} mined} \times {S}_{to \text{-} be \text{-} mined} \times {D}_{to \text{-} be \text{-} mined}}{{F}_{zhi mined} \times {S}_{mined} \times {D}_{mined}} \times {Q}_{mined} ,$$

where Q_{to-be-mined} represents the drainage water yield of the to-be-mined working face;

Q_{mined} represents the drainage water yield of the mined working face; F_{zhi to-be-mined} represents the average water abundance index of the to-be-mined working face; F_{zhi mined} represents the average water abundance index of the mined working face; S_{mined} represents the mining area of the mined working face; S_{to-be-mined} represents the mining area of the of the to-be-mined working face; D_{mined} represents an average mining height of the mined working face; and D_{to-be-mined} represents the designed mining height of the to-be-mined working face.

It should be noted that, when a roof of a coal seam is in a hard rock geological condition, water in the roof may not be drained in advance provided that a working face has a sufficient drainage capacity. In this case, it is only necessary to predict a water inflow quantity of the working face and conduct drainage according to the predicted water inflow quantity. A method for predicting a water inflow quantity of a working face is basically the same as that for predicting a drainage water yield of the to-be-mined working face. The only difference is that the drainage water yield of the mined working face is replaced by a water inflow quantity of the mined working face. The water inflow quantity of the mined working face can be extracted from the previously acquired data about the coal mine.

Specifically, a water inflow quantity of the to-be-mined working face is calculated according to a formula

$${Q}_{to \text{-} be \text{-} mined water inflow quantity} = \frac{{F}_{zhi to \text{-} be \text{-} mined} \times {S}_{to \text{-} be \text{-} mined} \times {D}_{to \text{-} be \text{-} mined}}{{F}_{zhi mined} \times {S}_{mined} \times {D}_{mined}} \times {Q}_{mined water inflow quantity} ,$$

where Q_{to-be-mined} water inflow quantity represents the water inflow quantity of the to-be-mined working face; Q_{mined} water inflow quantity represents the water inflow quantity of the mined working face; F_{zhi to-be-mined} represents the average water abundance index of the to-be-mined working face; F_{zhi mined} represents the average water abundance index of the mined working face; S_{mined} represents the mining area of the mined working face; S_{to-be-mined} represents the mining area of the to-be-mined working face; D_{mined} represents the average mining height of the mined working face; and D_{to-be-mined} represents the designed mining height of the to-be-mined working face.

The foregoing provides merely preferred embodiments of the present invention and is not intended to limit the present invention, and various changes and modifications may be made by a person skilled in the art. Any modifications, equivalent replacements, improvements, etc. within the spirit and principle of the present invention shall be included within the protection scope of the present invention.

What is claimed is:

1. A four-double working method for danger assessment and prediction of water inrush in a roof aquifer of a coal seam, comprising:
calculating a water abundance index and/or a danger index of water inrush of a roof of a to-be-mined coal seam according to position classification of the roof of the to-be-mined coal seam; and
obtaining a water inrush assessment result of the roof of the to-be-mined coal seam according to the water abundance index and/or the danger index of water inrush of the roof of the to-be-mined coal seam and excavation area position information of the roof of the to-be-mined coal seam.

2. The four-double working method for danger assessment and prediction of water inrush in a roof aquifer of a coal seam according to claim 1, wherein the calculating a water abundance index of a roof of a to-be-mined coal seam comprises:
obtaining borehole histogram information of all boreholes of the to-be-mined coal seam;
obtaining a coal seam thickness of an adjacent fractured aquifer of the to-be-mined coal seam according to the borehole histogram information;
obtaining a coal seam mining height according to the coal seam thickness;
obtaining a thickness of a theoretical research stratum according to the coal seam thickness and the coal seam mining height;
obtaining a thickness of an additional layer and a total thickness of a sandstone layer in a research section according to the lithology of the coal seam, a single layer thickness, and a burial depth of a floor;
obtaining a thickness of an adopted research stratum according to the thickness of the theoretical research stratum and the thickness of the additional layer; and
determining the water abundance index of the roof of the to-be-mined coal seam according to the total thickness of the sandstone layer in the research section and the thickness of the adopted research stratum.

3. The four-double working method for danger assessment and prediction of water inrush in a roof aquifer of a coal seam according to claim 2, wherein the obtaining a thickness of a theoretical research stratum according to the coal seam thickness and the coal seam mining height comprises:
calculating a height of a water flowing fractured zone and a thickness of a protective layer according to the coal seam mining height;
determining a revision value according to the coal seam thickness and the coal seam mining height; and
determining the thickness of the theoretical research stratum according to the revision value, the coal seam mining height, and the height of the water flowing fractured zone.

4. The four-double working method for danger assessment and prediction of water inrush in a roof aquifer of a coal seam according to claim 3, wherein the calculating a height of a water flowing fractured zone according to the coal seam mining height comprises:
calculating the height H_{D} of the water flowing fractured zone by using a formula H_{D}=100M÷(3.1M+5)+4, wherein M represents the coal seam mining height.

5. The four-double working method for danger assessment and prediction of water inrush in a roof aquifer of a coal seam according to claim 2, wherein the determining the water abundance index of the roof of the to-be-mined coal seam according to the total thickness of the sandstone layer in the research section and the thickness of the adopted research stratum comprises:
calculating the water abundance index F_{zhi} according to a formula
$${F}_{z h i} = \frac{{M}_{C}}{{H}_{Y}} \times 100 \% ,$$
wherein M_{C} represents the total thickness of the sandstone layer; and H_{Y} represents the thickness of the adopted research stratum.

6. The four-double working method for danger assessment and prediction of water inrush in a roof aquifer of a coal seam according to claim 2, wherein the calculating a danger index of water inrush of a roof of a to-be-mined coal seam comprises:
obtaining borehole histogram information of all boreholes of the to-be-mined coal seam;
obtaining a coal seam thickness of an adjacent fractured aquifer of the to-be-mined coal seam, an impervious layer thickness, and a thickness of a waterproof coal pillar according to the borehole histogram information;
obtaining a coal seam mining height according to the coal seam thickness;
determining a height of a water flowing fractured zone and a thickness of a protective layer according to the coal seam mining height; and
calculating the danger index of water inrush of the roof of the to-be-mined coal seam according to the height of the water flowing fractured zone, the impervious layer thickness, the thickness of the waterproof coal pillar, and the thickness of the protective layer.

7. The four-double working method for danger assessment and prediction of water inrush in a roof aquifer of a coal seam according to claim 6, wherein the calculating the danger index of water inrush of the roof of the to-be-mined coal seam according to the height of the water flowing fractured zone, the impervious layer thickness, the thickness of the waterproof coal pillar, and the thickness of the protective layer comprises:
calculating the danger index of water in rush Tₛ according to a formula
$${T}_{s} = \frac{{H}_{g} - {H}_{D} - {H}_{b} + {d}_{x}}{{H}_{f}} ,$$
wherein H_{g} represents the impervious layer thickness; H_{f} represents the thickness of the waterproof coal pillar; H_{D} represents the height of the water flowing fractured zone; and H_{b} represents the thickness of the protective layer.

8. The four-double working method for danger assessment and prediction of water inrush in a roof aquifer of a coal seam according to claim 2, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.

9. The four-double working method for danger assessment and prediction of water inrush in a roof aquifer of a coal seam according to claim 1, after the obtaining the water inrush assessment result of the roof of the to-be-mined coal seam, further comprising:
if the water inrush assessment result indicates that water inrush danger satisfies a preset condition, calculating a drainage water yield of a to-be-mined working face of the to-be-mined coal seam according to the water abundance index of the to-be-mined coal seam and a preset algorithm.

10. The four-double working method for danger assessment and prediction of water inrush in a roof aquifer of a coal seam according to claim 9, wherein the calculating a drainage water yield of a to-be-mined working face of the to-be-mined coal seam according to the water abundance index of the to-be-mined coal seam and a preset algorithm comprises:
obtaining a drainage water yield, a mining area, and a mining height of a mined working face;
calculating an average water abundance index of the mined working face according to water abundance indexes corresponding to all boreholes of the mined working face;
determining a mining area of the to-be-mined working face; determining a designed mining height of the to-be-mined working face;
calculating an average water abundance index of the to-be-mined working face according to water abundance indexes corresponding to all boreholes of the to-be-mined working face; and
predicting a drainage water yield of the to-be-mined working face according to a formula
$${Q}_{to \text{-} be \text{-} mined} = \frac{{F}_{zhi to \text{-} be \text{-} mined} \times {S}_{to \text{-} be \text{-} mined} \times {D}_{to \text{-} be \text{-} mined}}{{F}_{zhi mined} \times {S}_{mined} \times {D}_{mined}} \times {Q}_{mined} ,$$
wherein Q_{to-be-mined} represents the drainage water yield of the to-be-mined working face; Q_{mined} represents the drainage water yield of the mined working face; F_{zhi to-be-mined} represents the average water abundance index of the to-be-mined working face; F_{zhi mined} represents the average water abundance index of the mined working face; S_{mined} represents the mining area of the mined working face; S_{to-be-mined} represents the mining area of the to-be-mined working face; D_{mined} represents an average mining height of the mined working face; and D_{to-be-mined} represents the designed mining height of the to-be-mined working face.

11. The four-double working method for danger assessment and prediction of water inrush in a roof aquifer of a coal seam according to claim 3, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.

12. The four-double working method for danger assessment and prediction of water inrush in a roof aquifer of a coal seam according to claim 4, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.

13. The four-double working method for danger assessment and prediction of water inrush in a roof aquifer of a coal seam according to claim 5, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.

14. The four-double working method for danger assessment and prediction of water inrush in a roof aquifer of a coal seam according to claim 6, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.

15. The four-double working method for danger assessment and prediction of water inrush in a roof aquifer of a coal seam according to claim 7, wherein the obtaining a water inrush assessment result of the roof of the to-be-mined coal seam according to the water abundance index and/or the danger index of water inrush of the roof of the to-be-mined coal seam and excavation area position information of the roof of the to-be-mined coal seam comprises:
drawing a contour map of water abundance according to the water abundance index;
drawing a contour map of water inrush danger according to the danger index of water inrush; and
obtaining the water inrush assessment result of the roof of the to-be-mined coal seam according to the contour map of water abundance, the contour map of the water inrush danger, and the excavation area position information of the roof of the to-be-mined coal seam.
